(19) United States
(12) Patent Application Publication
(10) Pub. No.: US 2011/0013573 A1
(43) Pub. Date: Jan. 20, 2011

(54) METHOD FOR REQUESTING BANDWIDTH IN A WIRELESS ACCESS SYSTEM

(76) Inventors: Jeong Ki Kim, Anyang-si (KR); Ki Seon Ryu, Anyang-si (KR); Sung Woong Ha, Anyang-si (KR); Chang Hun Lee, Anyang-si (KR)

Correspondence Address: BIRCH STEWART KOLASCH & BIRCH, PO BOX 747, FALLS CHURCH, VA, 22040-0747, US

(21) Appl. No.: 12/747,445

(22) PCT Filed: Dec. 11, 2008
(86) PCT No.: PCT/KR08/07331

§ 371 Date: Sep. 3, 2010

(30) Foreign Application Priority Data
Dec. 11, 2007 (KR) 10-2007-0128397

(51) Int. Cl. H04W 72/04

(52) U.S. Cl. 370/329

(57) ABSTRACT

A method for requesting a bandwidth in a wireless access system is disclosed. In the method for requesting a bandwidth in a wireless access system, when a base station receives an uplink MAC PDU from a mobile station, if there is a polling request field in a generic MAC header, the base station allocates a bandwidth, which can transmit a BR header, to the mobile station. Then, the mobile station transmits a BR header to a region allocated from the base station so as to be allocated with a resource for transmitting data from the base station and to transmit data to the region.

### TECHNICAL FIELD

The present invention relates to a wireless access system, and more particularly, to a method for requesting a bandwidth in a wireless access system.

### BACKGROUND ART

FIG. 1 is a flow chart illustrating a method for requesting a bandwidth in a broadband wireless access system (wireless MAN-OFDMA) which is one of wireless access systems.

If a mobile station has data to be transmitted, the mobile station optionally selects a ranging code for requesting a bandwidth from a subset of a code in step S11, and then transmits the selected code to a ranging subchannel. A base station which has received the code transmits CDMA_Allocation_IE to the mobile station through UL-MAP, wherein the CDMA_Allocation_IE includes information of a region where the mobile station can transmit a bandwidth request (BR) header, in step S12. The mobile station transmits the BR header, which includes a size of data to be transmitted, to the region allocated to the CDMA_Allocation_IE in step S23. The base station which has received the BR header allocates a bandwidth to the mobile station and notifies the mobile station of it in step S14. The mobile station can transmit data to the allocated region in step S15.

As illustrated in FIG. 1, since the bandwidth is allocated using a ranging code based on a contention based bandwidth request, when the mobile station transmits a ranging code to a ranging channel, the mobile station may collide with another mobile station. In this case, the mobile station cancels it and then transmits the ranging code to the base station. For this reason, delay in data transmission may occur.

### DISCLOSURE OF INVENTION

### Technical Problem

Accordingly, the present invention is directed to a method for requesting a bandwidth in a wireless access system, which substantially obviates one or more problems due to limitations and disadvantages of the related art.

### Technical Solution

To achieve these objects and other advantages and in accordance with the purpose of the invention, as embodied and broadly described herein, a method for requesting a bandwidth in a wireless access system according to one embodiment of the present invention comprises transmitting a MAC header in which a polling request field value is set; transmitting a bandwidth request message using a resource allocated through response to polling request, the bandwidth request message including required bandwidth information; and transmitting data using a resource allocated through response to the bandwidth request message.

The polling request field is comprised of 1 bit, and is set to ‘1’ if there is polling request and set to ‘0’ if there is no polling request. Data for the polling request are related with data currently transmitted and received. Also, the bandwidth request message is defined by a header format transmitted without payload.

If a grant management subheader (GMSH) is transmitted to notify necessity of bandwidth management during data transmission and reception, polling is requested through either the GMSH or the MAC Header.

Meanwhile, if a channel quality information channel (CQICH) for reporting channel status is allocated, polling is requested through either a codeword of the CQICH or the MAC Header.

### Advantageous Effects

The mobile station can request an uplink bandwidth more efficiently through the method for requesting a bandwidth in a wireless access system according to the present invention.

Also, according to the embodiment of the present invention, the mobile station can avoid collision with another mobile station, which may occur as the mobile station requests the base station of a bandwidth in accordance with a contention based bandwidth request.

Moreover, as such collision is previously avoided, delay that may occur during contention based bandwidth request can be reduced.

Since the mobile station can request additional bandwidth by requesting polling without transmitting a separate subheader, it is possible to enhance data transmission efficiency.

Finally, even in case that an uplink channel other than an uplink data transmission channel is not allocated, the mobile station can request additional bandwidth by easily requesting polling.

### BRIEF DESCRIPTION OF DRAWINGS

FIG. 1 is a flow chart illustrating a method for requesting a bandwidth in a broadband wireless access system (MAN-OFDMA) which is one of wireless access systems;

FIG. 2 is a diagram illustrating an example of a MAC protocol data unit (MAC PDU) defined in a broadband wireless access system;

FIG. 3 is a diagram illustrating an example of a generic MAC header used in a broadband wireless access system according to one embodiment of the present invention;

FIG. 4 is a flow chart illustrating an example of a method for requesting a bandwidth in accordance with one embodiment of the present invention;

FIG. 5 is a flow chart illustrating an example of a method for requesting a bandwidth in accordance with another embodiment of the present invention; and

FIG. 6 is a flow chart illustrating an example of a method for requesting a bandwidth in accordance with other embodiment of the present invention.

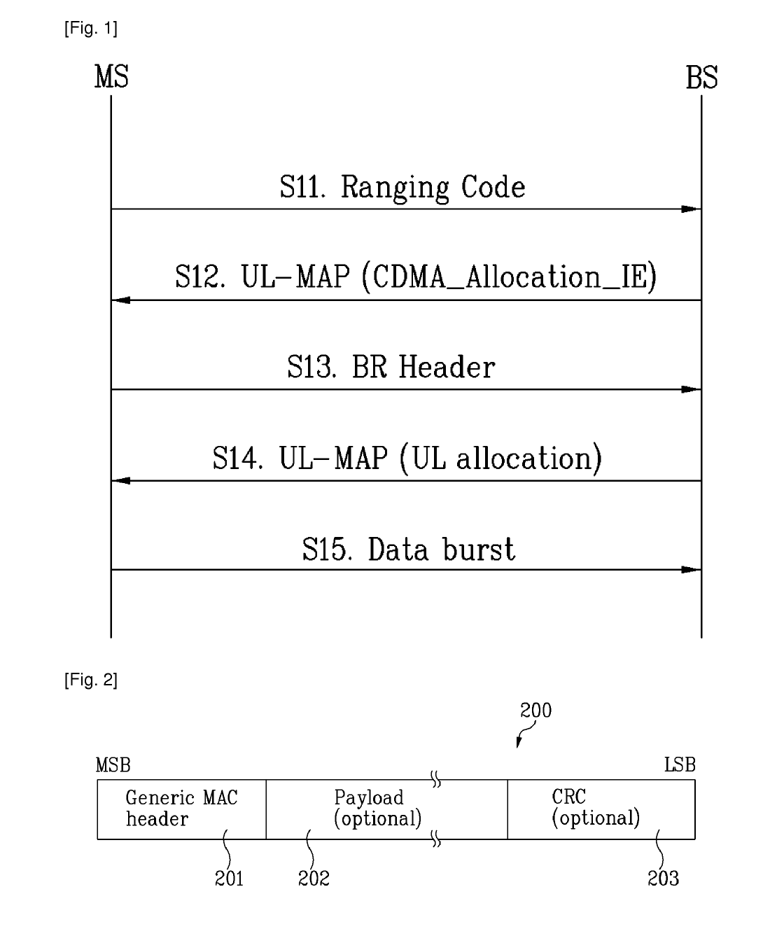

### MODE FOR THE INVENTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. Hereinafter, the following detailed description includes detailed matters to provide full understanding of the present invention. However, it will be apparent to those skilled in the art that the present invention can be carried out without the detailed matters. For example, although the following description will be made based on some terminologies, the following description will not be limited to such terminologies and other terminologies may be designated as same meaning.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

The embodiments of the present invention have been described based on the data transmission and reception between a base station and a mobile station. In this case, the base station means a terminal node of a network, which performs direct communication with the mobile station. A specific operation which has been described as being performed by the base station may be performed by an upper node of the base station as the case may be. In other words, it will be apparent that various operations performed for communication with the mobile station in the network which includes a plurality of network nodes along with the base station may be performed by the base station or network nodes other than the base station. The base station may be replaced with terms such as a fixed station, Node B, eNode B (eNB), and access point. Also, the mobile station may be replaced with terms such as a user equipment and a mobile subscriber station.

The present invention provides a method for using a generic MAC header if a mobile station intends to request a bandwidth while transmitting uplink MAC PDU.

Generally, in a link layer (or MAC layer) and a physical layer below a second layer, a protocol according to each system such as LAN, Wireless LAN, 3GPP/3GPP2, and Wireless MAN and a header format of MAC PDU according to the protocol are defined differently from each other.

FIG. 2 is a diagram illustrating an example of a MAC protocol data unit defined in a broadband wireless access system.

As illustrated in FIG. 2, a MAC PDU 200 includes a generic MAC header 201, and selectively includes a payload 202 and a cyclic redundancy check (CRC) 203. The MAC header 201 includes a MAC address or link address of nodes for data transfer between the respective nodes in the link layer, and can include header error check and link layer control information.

Referring to FIG. 2, each MAC PDU 200 starts with a MAC header 201 of a certain length. The generic MAC header 201 can be located in front of the payload 202 of the MAC PDU, as illustrated in FIG. 2. If there is provided the header 201, the payload 202 includes a subheader, MAC SDU, and fragment. A length of payload information may be varied to express variable bytes. In this case, MAC sublayer can transmit various traffic types of an upper layer even without recognizing format or bit pattern of a message. Also, the MAC PDU 200 can include cyclic redundancy check 203 for error detection.

Generally, a single downlink MAC header is provided and can be located in front of each MAC PDU which transmits management message and convergence sublayer (CS) data. The uplink MAC header can be defined by two formats, one of which is a generic MAC header located in front of each MAC PDU, wherein each MAC PDU includes management message and CS data, and the other of which is a MAC signaling header transmitted without payload and neither PDU payload nor CRC is provided at the rear of the MAC signaling header.

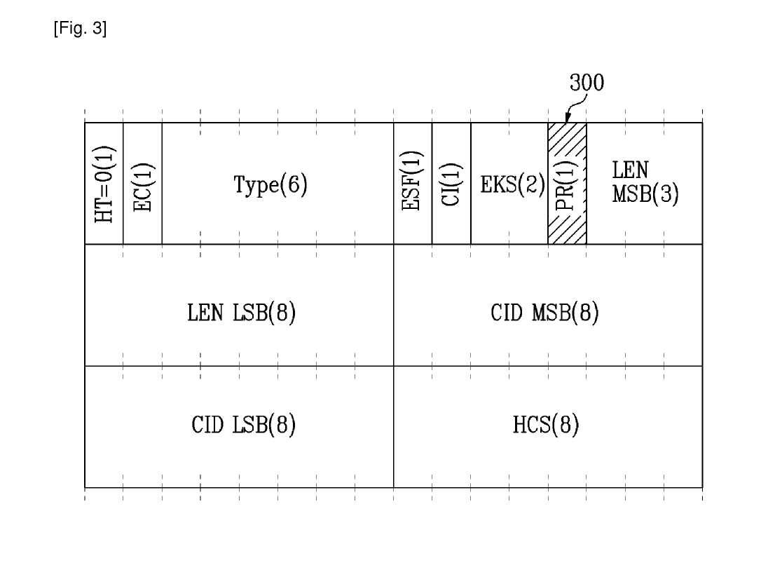

FIG. 3 is a diagram illustrating an example of a generic MAC header used in a broadband wireless access system according to one embodiment of the present invention.

Referring to FIG. 3, six subheaders can be used in the MAC PDU together with a generic MAC header. A subheader per PDU is inserted to the rear of the generic MAC header. Each field included in the generic MAC header will be described below.

An HT field represents a header type, more particularly represents whether a corresponding MAC PDU is a generic MAC header which includes payload at the rear or a signaling header for control such as bandwidth request. An EC field represents encryption control, more particularly represents whether payload has been encrypted. A Type field represents the presence of a subheader suffixed next to the header and a type of the subheader. An ESF field represents the presence of an enlarged subheader suffixed next to the header.

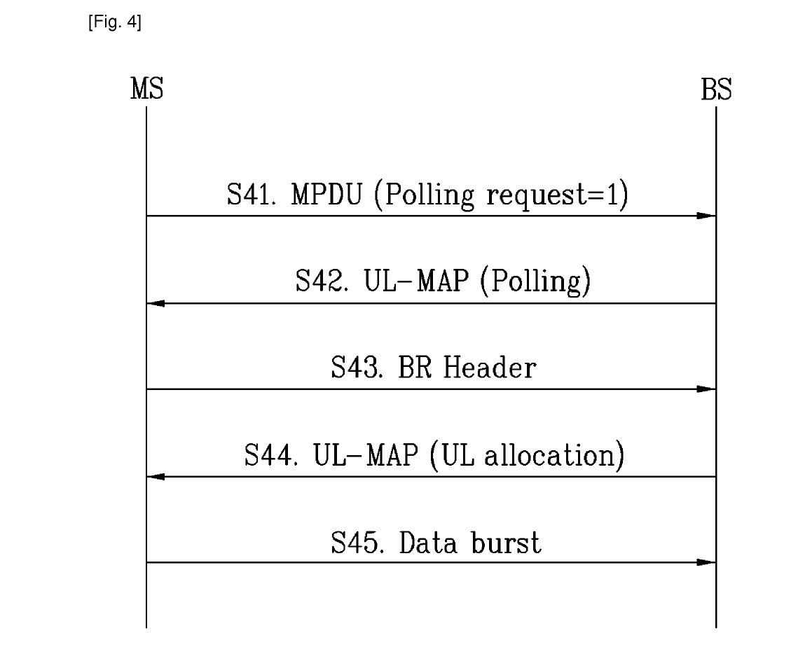

Also, a CI field represents whether CRC is suffixed to the rear of payload. An EKS field represents an encryption key sequence number used for encryption if payload encrypted. A LEN field represents a length of MAC PDU. A CID (connection identifier) field represents a connection identifier to which MAC PDU is transferred. Connection is used as an identifier of a MAC layer for data and message transfer between the base station and the mobile station. CID serves to identify a specific mobile station or a specific service between the base station and the mobile station. A header check sequence (HCS) is used to detect an error of the header. In FIG. 4, in a number in a parenthesis next to each field name represents bits occupied by each field.

According to this embodiment, the mobile station can request polling while transmitting the MAC PDU through a polling request (PR) field. In this case, polling means a process for allocating a bandwidth from a base station to mobile stations to allow the mobile stations to request a bandwidth. When the base station receives the MAC PDU, if a PR field requesting polling of the MAC header is set, the base station allocates a bandwidth, which can be then used to transmit a bandwidth request header for bandwidth request, to the mobile station.

For example, the PR field can be comprised of 1 bit. In this case, if there is polling request of the corresponding mobile station, the PR field value can be set to ‘1’. If there is no polling request of the corresponding mobile station, the PR field value can be set to ‘0’. When the base station receives the MAC PDU, if the PR field of the MAC header is set to ‘1’, the base station can allocate a bandwidth, which can be then used to transmit the BR header, to the mobile station.

FIG. 4 is a flow chart illustrating an example of a method for requesting a bandwidth in accordance with one embodiment of the present invention.

If there are data to be transmitted while the mobile station is transmitting data, the mobile station sets the PR field of the MAC header to ‘1’ and then transmits the MAC PDU to the base station in step S41. The base station receives the MAC PDU from the mobile station, and if the PR field is set to ‘1’, the base station allocates a resource to the mobile station to allow the mobile station to transmit the BR header that can request a bandwidth. The base station transmits information on a resource allocation through UL-MAP message to the corresponding mobile station in step S42. In this case, the UL-MAP message is a message representing an uplink channel access method, and can be generated using parameters such as UCD count, allocation start time, Map IE.

Then, the mobile station can identify the allocated resource acquired through the UL-MAP message and transmit the BR header to the base station through the allocated region in step S43. In this case, the BR header is a kind of the MAC signaling header transmitted without payload and includes information indicating connection of a target which the mobile station requests an uplink bandwidth and the number of bytes which require the bandwidth. This BR header may be transmitted together with a header for uplink transmission power report and CINR report. Also, the bandwidth requested in the BR header could be the incremental bandwidth as compared with the current bandwidth.

The base station which has received the BR header from the mobile station allocates a resource, which can be then used to transmit data, to the mobile station, and transmits information on uplink resource allocated through the UL-MAP message in step S44. The mobile station identifies the allocated uplink resource and transmits data through the uplink resource in step S45.

If the mobile station requests a bandwidth in accordance with this embodiment, delay can be reduced as compared with the case where the aforementioned contention based ranging code is transmitted to request a bandwidth.

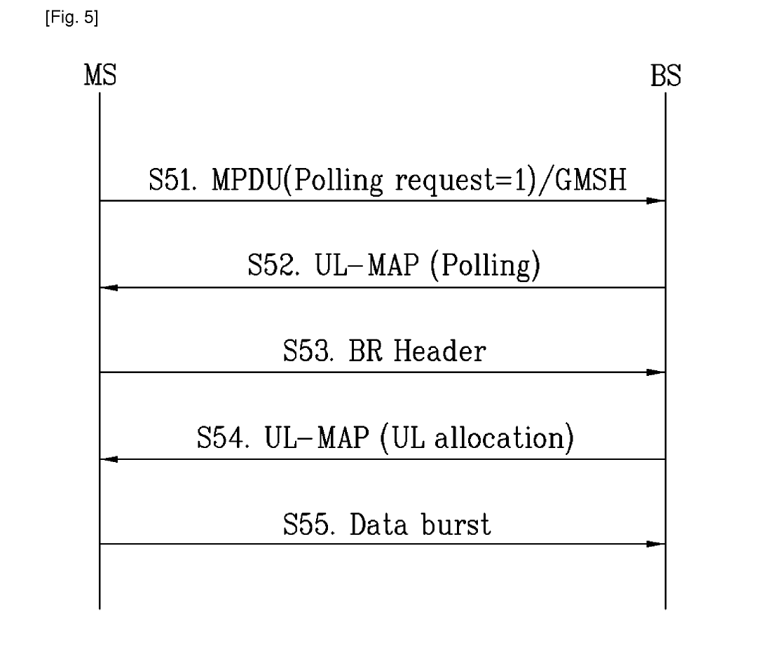

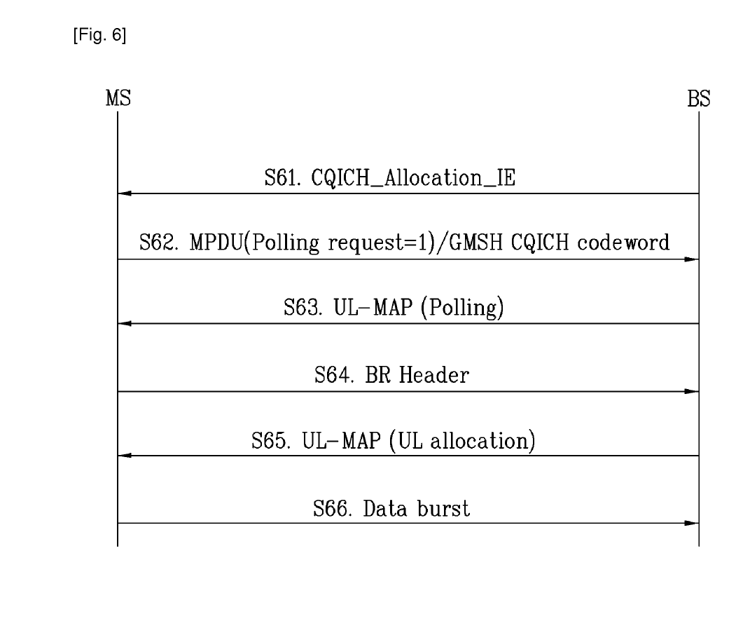

FIG. 5 is a flow chart illustrating an example of a method for requesting a bandwidth in accordance with another embodiment of the present invention.

As the mobile station is allocated with a resource from the base station to transmit data and has more data to be transmitted, if the region allocated to the mobile station to transmit data is sufficient to include a grant management subheader (GMSH), the mobile station can use the GMSH to additionally request a bandwidth. The GMSH can be used when necessity of bandwidth management is notified from the mobile station to the base station. This subheader can be encoded differently depending on types of uplink scheduling service according to connection ID for access.

Table 1 illustrates an example of GMSH format.

TABLE 1

| Syntax | Size | Notes |
|---|---|---|
| Grant Management | | |
| SubHeader { | | |
| if (scheduling service type | | |
| == UGS) { | | |
| SI | 1bit | |
| PM | 1bit | |
| FLI | 1bit | |
| FL | 4bits | |
| Reserved | 9bits | Shall be set to zero |
| } else if (scheduling service | | |
| type == Extended rtPS) { | | |
| Extended piggyback | 11 bits | |
| request | | |
| FLI | 1bit | |
| FL | 4bits | |
| } else{ | | |
| Piggyback Request | 16 bits | |
| } | | |
| } | | |

According to Table 1, it is noted that the GMSH can have a length of 2 bytes and can be encoded differently based on types (for example, UGS, ErtPS, etc.) of uplink scheduling service for connection.

If the uplink scheduling service type is an unsolicited grant service (UGS) designed to provide a function of a real-time uplink service flow which periodically generates data packets of a given size, SI field, PM field, FLI field, and FL field are set.

The SI field represents whether to indicate sleep of uplink grants related to an uplink queue length, and the PM field represents whether to request bandwidth polling. The FLI field represents whether a frame delay field is available with respect to the corresponding grant, and the FI field represents the number of frames prior to those that can be used by the transmitted data.

If the uplink scheduling service type is an extended real-time polling service (ErtPS) designed to support a function of a real-time uplink service flow which periodically generates data packets of a variable length, an extended piggyback request field representing a size of an uplink bandwidth requested from the mobile station, an FLI field, and FL field are set. The bandwidth requested through the extended piggyback request field is related with current CID, and the FLI field and the FI field are the same as aforementioned.

In other cases, a piggyback request (PBR) field representing a size of the requested uplink bandwidth is set.

In other words, if the mobile station is allocated with a resource from the base station to transmit data and has more data to be transmitted, the mobile station can additionally request a bandwidth by transmitting the GMSH subsequent to the generic MAC header in step S51. If a separate subheader is additionally transmitted for polling request in accordance with this embodiment, the PR field of the generic MAC header can be used to represent other information.

Then, the same steps as those of FIG. 4 can be performed. Namely, the base station notifies bandwidth information allocated by polling through the uplink MAP message in step S52, and the mobile station transmits the BR header to request a bandwidth for additional data transmission using the allocated bandwidth in step S53. Then, the base station allocates an uplink resource required for the corresponding mobile station, i.e., a bandwidth in accordance with the BR header and notifies it through uplink MAP message in step S54. Then, the mobile station can transmit additional data through the allocated resource in step S55.

According to the embodiment of the present invention, even in case that the region allocated to transmit data is sufficient to include the GMSH, as described with reference to FIG. 3 and FIG. 4, the mobile station can request polling, i.e., a bandwidth for BR header transmission using the PR field within the generic MAC header. Also, the mobile station can use the resource, which can be used to transmit the GMSH, for additional data transmission.

FIG.. 6 is a flow chart illustrating an example of a method for requesting a bandwidth in accordance with other embodiment of the present invention.

As the mobile station is allocated with a resource from the base station to transmit data and has more data to be transmitted, if CQICH is allocated, the mobile station can transmit a CQICH code for bandwidth request through the CQICH so that the base station allocates a bandwidth to the mobile station.

If the CQICH is allocated, the base station transmits CQICH allocation IE (CQICH_Allocation_IE) to the mobile station so as to dynamically allocate the CQICH to the mobile station in step S61. The CQICH allocation IE is to dynamically allocate CQICH to the mobile station or release the CQICH. If the CQICH is allocated, the mobile station can transmit quality information of the channel through the CQICH allocated to the frame continuously transferred to the mobile station.

If the mobile station has data to be additionally transmitted and can use the CQICH, the mobile station can request the base station of a bandwidth by transmitting CQICH codeword to the allocated CQICH in step S62. The base station, which has received the CQICH codeword for bandwidth request through the CQICH, allocates a resource region for transmitting a BR header to the mobile station and notifies it through the uplink MAP message in step S63.

Then, the mobile station transmits a BR header, which includes a size of data to be transmitted using the allocated region in step S64. The base station which has received the BR header can allocate a bandwidth to the mobile station and notify it through the uplink MAP message in step S65. The mobile station identifies the allocated region by receiving the uplink MAP message, and transmits data through the allocated resource region in step S66.

According to the embodiment of the present invention, even in case that the CQICH is allocated, as described with reference to FIG. 3 and FIG. 4, the mobile station can request polling, i.e., a bandwidth for BR header transmission using the PR field within the generic MAC header without transmitting a CQICH codeword to request the base station of a bandwidth.

According to the embodiment of the present invention, the mobile station can avoid collision with another mobile station, which may occur as the mobile station requests the base station of a bandwidth by transmitting a ranging code in accordance with a contention based bandwidth request. Also, as such collision is previously avoided, delay that may occur during contention based bandwidth request can be reduced.

Since the mobile station can request additional bandwidth by requesting polling without transmitting a separate subheader, it is possible to enhance data transmission efficiency. In addition, even in case that an uplink channel other than an uplink data transmission channel is not allocated, the mobile station can request additional bandwidth by easily requesting polling.

It will be apparent that some claims referring to specific claims may be combined with another claims referring to the other claims other than the specific claims to constitute the embodiment or add new claims by means of amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

1. A method for requesting a bandwidth in a wireless access system, the method comprising:
transmitting a MAC header in which a polling request field value is set;
transmitting a bandwidth request message using a resource allocated through response to polling request, the bandwidth request message including required bandwidth information; and
transmitting data using a resource allocated through response to the bandwidth request message.

2. The method of claim 1, wherein the polling request field is comprised of 1 bit, and is set to ‘1’ if there is polling request and set to ‘0’ if there is no polling request.

3. The method of claim 1, wherein data for the polling request are related with data currently transmitted and received.

4. The method of claim 1, wherein the bandwidth request message is defined by a header format transmitted without payload.

5. The method of claim 1, wherein if a grant management subheader (GMSH) is transmitted to notify necessity of bandwidth management during data transmission and reception, polling is requested through either the GMSH or the MAC Header.

6. The method of claim 1, wherein if a channel quality information channel (CQICH) for reporting channel status is allocated, polling is requested through either a codeword of the CQICH or the MAC Header.
